(19) United States
(12) Patent Application Publication
(10) Pub. No.: US 2026/0160358 A1
(43) Pub. Date: Jun. 11, 2026

(54) Flow Rate Control Valve

(71) Applicants: Hyundai Motor Company, Seoul (KR); Kia Corporation, Seoul (KR); Dong-A University Research Foundation for Industry-Academy Cooperation, Busan (KR)

(72) Inventors: Sung Jae Lee, Hwaseong-si (KR); Seung Ho Han, Seoul (KR); Hyung Joon Park, Busan (KR)

(21) Appl. No.: 19/248,691

(22) Filed: Jun. 25, 2025

(30) Foreign Application Priority Data
Dec. 9, 2024 (KR) 10-2024-0181917

(51) Int. Cl. F16K 39/02; F16K 31/06; F16K 31/10; F17C 13/04

(52) U.S. Cl. CPC F16K 39/024; F16K 31/0655; F16K 31/10; F16K 2200/30; F17C 13/04; F17C 2205/0323

(57) ABSTRACT

A flow rate control valve is provided by which an operation of a solenoid valve is operated more accurately and smoothly even when a larger difference pressure occurs between a hydrogen storage tank and a pipeline.

### CROSS-REFERENCE TO RELATED APPLICATION

This application claims the benefit of priority to Korean Patent Application No. 10-2024-0181917, filed in the Korean Intellectual Property Office on Dec. 9, 2024, the entire contents of which are incorporated herein by reference.

### TECHNICAL FIELD

The present disclosure relates to a flow rate control valve.

### BACKGROUND

A fuel cell electric vehicle (FCEV) may include a fuel cell stack that generates electric energy, a fuel supply system that supplies a fuel (hydrogen) to the fuel cell stack, an air supply system that supplies oxygen in air that is an oxidizing agent required for electrochemical reactions, to the fuel cell stack, and a heat/water management system that controls an operation temperature of the fuel cell stack.

A hydrogen filling line of the fuel supply system may be provided with a hydrogen storage tank in which high-pressure (e.g., about 700 bar) compressed hydrogen is stored. The compressed hydrogen stored in the hydrogen storage tank may be discharged to a high-pressure line by a high-pressure regulator provided at an inlet of the hydrogen storage tank. The discharged hydrogen may be decompressed through/via a start valve and a hydrogen supply valve, and supplied to the fuel cell stack.

Between the hydrogen storage tank of the fuel supply system and the fuel cell stack, a pipeline for feeding hydrogen, a configuration for fitting the pipe, a regulator for controlling a pressure of hydrogen, and a solenoid valve as a flow rate control valve for blocking and supplying a hydrogen fuel may be installed.

However, in a process of achieving temperature balance after driving a vehicle, because a high differential pressure may occur between the hydrogen storage tank and the pipeline for feeding hydrogen to the fuel cell stack, the solenoid valve may not be opened.

Therefore, to solve this problem, as disclosed in the patent document (KR 10-2501492) a solenoid valve may have a valve structure in which a hydrogen fuel filled in a first chamber, in which the pilot valve is located, may be discharged through an orifice when a pilot valve is raised, and the hydrogen fuel in an interior of the first chamber may become a low-pressure state, and a main valve may be raised by a differential pressure from a second chamber, in which the main valve is located, to secure a flow rate.

However, the flow rate of the hydrogen fuel introduced into the first chamber through the inlet may be greater than the flow rate of hydrogen fuel discharged through the orifice, so that the pressure of the hydrogen fuel in the interior the first chamber does not change to a low pressure state, and a differential pressure between the first chamber and the second chamber does not occur.

If the main valve (e.g., a second valve unit) is not operated normally due to a lack of the differential pressure between the first and second chambers, a failure of a solenoid valve may occur, and thus, customers raise complaints about vehicle driving.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a flow rate control valve. A flow rate control valve may comprise: a body comprising a lower portion in which an inlet and an outlet are formed; a coil installed on an outer peripheral surface of the body, and configured to apply a magnetic field; a solenoid core installed in a hollow portion of the body, and configured to induce the magnetic field applied by the coil; a first valve plunger moveably installed in the hollow portion of the body; and a second valve plunger disposed to be movable in conjunction with the first valve plunger, and having an orifice in an interior the second valve plunger. The body may forms a first space between the first valve plunger and the second valve plunger and forms a second space between the second valve plunger and the outlet, wherein the second space has a larger diameter than the first space, the first valve plunger is configured to block the first space in a state in which the first valve plunger is raised, and the second valve plunger is configured to, based on a differential pressure between the first space and the second space, be positioned in a state in which the outlet is open.

Also, or alternatively, a flow rate control valve may comprise: a body comprising a lower portion forming an inlet; a valve seat attached to the lower portion of the body and forming an outlet; a conductive coil attached to an upper portion of the body; a solenoid core arranged inside the conductive coil; a first valve plunger comprising a side protrusion protruding outward around a circumference of the first valve plunger; and a second valve plunger, movable installed in the body, comprising: an upper cylindrical portion, wherein an inner surface of the upper cylindrical portion comprises an inward step; and a lower orifice portion that forms an orifice. The first valve plunger may be moveably inserted within the upper cylindrical portion such that the side protrusion is in contact with the inner surface of the upper cylindrical portion below the inward step, and a first space may be formed between the side protrusion, a side of the first valve plunger, and the second valve plunger, and a second space is formed between the second valve plunger, the body, and the valve seat, wherein the second space has a larger diameter than the first space.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view illustrating a valve assembly of a hydrogen storage tank according to an example of the present disclosure;

FIG. 2 is a cross-sectional view illustrating a flow rate control valve according to an example of the present disclosure;

FIG. 3 is a perspective view illustrating a coupled state of first and second plungers of a second valve unit according to an example of the present disclosure.

FIG. 4 is a cross-sectional view of FIG. 3;

FIG. 5 is a cutaway perspective view illustrating an upper plunger according to an example of the present disclosure;

FIG. 6 is a cutaway perspective view illustrating a coupled state of an upper plunger and a lower plunger according to an example of the present disclosure; and

FIGS. 7 and 8 are operation views illustrating an operation state of a flow rate control valve according to an example of the present disclosure.

### DETAILED DESCRIPTION

Hereinafter, some examples of the present disclosure will be described in detail with reference to the accompanying drawings. In adding reference numerals to the components of the drawings, it should be noted that the same components have the same numerals as possible even when they are illustrated on different drawings. In describing examples of the present disclosure, detailed descriptions associated with well-known functions or configurations will be omitted if they may make subject matters of the present disclosure unnecessarily obscure.

Furthermore, in describing components of examples of the present disclosure, the terms first, second, A, B, (a), (b), and the like may be used herein. These terms are only used to distinguish one element from another element, but do not limit the corresponding elements irrespective of the nature, order, or priority of the corresponding elements. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

In the present disclosure, one or more controllers (e.g., a control device, a control unit, etc.) may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. A controller may include a communication device communicating with other controllers and/or a sensor to control one or more functions and/or operations in charge (e.g., operation of a valve unit, valve assembly, valve, or other components herein), a memory storing an operation system, a logic command, and input/output information, and/or one or more processors performing determination, calculation, and decision necessary for controlling the function in charge. A controller may manipulate and/or control other components in the system (e.g., vehicle).

A user interface may comprise a device through which a human user can interact with a device. The user interface may include an input interface that can receive an input from the human user and/or an output interface through which data or information can be output to the human user. An input interface may include, for example, a button, a knob, a toggle, a switch, a dial, a slider, a keyboard, a touchscreen, a microphone, a camera, a wheel, a pedal, a lever, etc. An output interface may include, for example, a light, a lamp, an indicator, a screen, a display, a console, a meter, a gauge, a speaker, etc.

Hereinafter, a flow rate control valve according to various examples of the present disclosure will be described in detail with reference to the accompanying drawings.

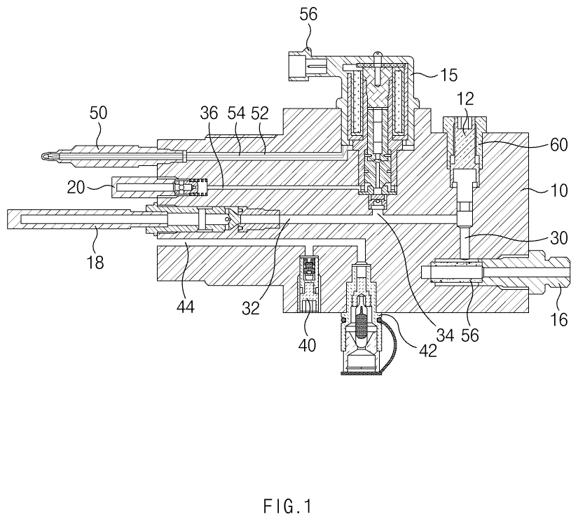

FIG. 1 is a cross-sectional view illustrating a valve assembly of a hydrogen storage tank according to an example of the present disclosure.

The valve assembly of the hydrogen storage tank according to an example of the present disclosure may include a valve body 10 that is installed in a hydrogen storage tank (not illustrated), in which a hydrogen fuel is stored, a manual valve 12 that is installed in the valve body 10 and configured to manually open and/or close a passage through which the hydrogen fuel passes, and a solenoid valve 15 that is installed in the valve body 10 and configured to automatically open and/or close the passage according to an electrical signal.

An outlet pipe 16, to which an external hydrogen fuel line is connected, and through which the hydrogen fuel enters and exits, a filling pipe 18 that is inserted into and/or disposed in the hydrogen storage tank, and through which the hydrogen fuel passes to filled into an interior of the hydrogen storage tank, and a use pipe 20, through which the hydrogen fuel passes to be used (e.g., supplied to a fuel cell stack for use), may be installed in the valve body 10.

A plurality of passages, through which hydrogen may flow, may be formed in the valve body 10. A first passage 30 may be connected to the outlet pipe 16 and the manual valve 12 to allow hydrogen fuel flow therebetween. A second passage 32 may be connected to the manual valve 12 and the filling pipe 18 to allow hydrogen fuel flow therebetween. A third passage 34 may be branched from the second passage 32 connected to the solenoid valve 15 to allow hydrogen fuel flow therebetween. A fourth passage 36 may be connected to the solenoid valve 15 and the use pipe 20 to allow hydrogen fuel flow therebetween.

The second passage 32 may have a large inner diameter so that the hydrogen fuel may be filled to the hydrogen storage tank 100 in a short time. The fourth passage 36 may have a smaller inner diameter than that of the second passage 32 because the hydrogen fuel stored in the hydrogen storage tank is supplied to the user (e.g., fuel cell stack) and does not require the as high a flow rate.

An overcurrent cutoff valve 40 (EFV) and a pressure release valve 42 may be provided/installed in the valve body 10. The EFV 40 may be configured to prevent the hydrogen fuel in the interior of the hydrogen storage tank from being abnormally and/or excessively discharged (e.g., when/if a pipeline is cut in case of a vehicle accident or rollover accident). The PRV 42 may be configured to discharging the hydrogen fuel to the outside when a pressure in the hydrogen storage tank rises due to temperature when a fire occurs due to a vehicle accident.

The overcurrent cutoff valve 40 and the pressure release valve 42 may be connected to a fifth passage 44 formed in the valve body 10, and the fifth passage 44 may be connected to the hydrogen storage tank, so that the hydrogen fuel stored in the hydrogen storage tank may be introduced into the fifth passage 44.

A temperature sensor 50 may sense/measure the temperature of the interior of the hydrogen storage tank. The temperature sensor may be installed in the valve body 10. The temperature sensor 50 may transmit a signal based on the temperature (e.g., the temperature and/or an indication that the temperature has satisfied a condition, such as exceeding a threshold temperature, dropping below a threshold temperature, etc.) to a controller (e.g., continuously, as generated/in real-time, periodically.

A cable 54 connected to the temperature sensor 50 may pass through a passage 52 that is formed in the valve body 10 and may be connected to a connector 56 of a solenoid valve 15.

The cable 54 electrically connected to the temperature sensor 50 being integrated into the valve body 10 and connected to the connector 56 of the solenoid valve 15 simplifies the structure of the valve assembly as a separate connector for connecting the cable 54 is unnecessary.

The hydrogen storage tank 100 may be/comprise container that may safely store the hydrogen fuel of 700 bar or more.

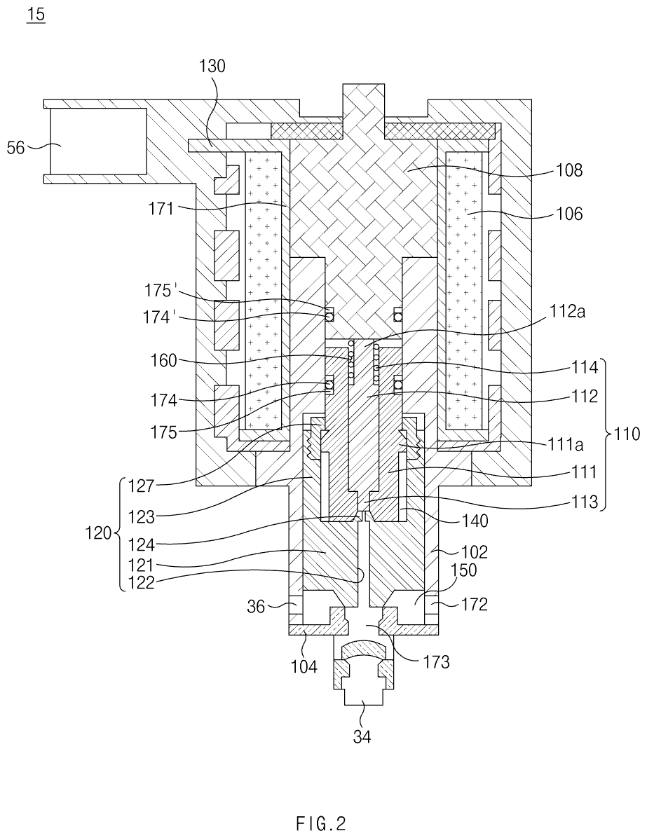

FIG. 2 is a cross-sectional view illustrating a flow rate control valve according to an example of the present disclosure, and a solenoid valve 15 that is a flow rate control valve will be described.

As illustrated in FIG. 2, the solenoid valve 15 may connect and/or open the third passage 34 and/or the fourth passage 36 (e.g., if/when the hydrogen fuel is supplied to the user/fuel cell stack).

The solenoid valve 15 may include a body part 102 (e.g., body, housing, etc.) that is installed on the valve body 10, a valve seat 104 installed at a lower portion of the body part 102 and communicates with the third passage, a coil 106 installed on an outer peripheral surface of the body part 102, and to which a magnetic field may be applied, a first valve unit 110 (e.g., a first valve plunger) installed on an inner peripheral surface of the body part 102, and a second valve unit 120 (e.g., a second valve plunger) that is operated in conjunction with the first valve unit 110 and is closely attached to or separated from the valve seat 104 to open and close the passage, respectively. The first valve unit 110 may be moveably installed to be moved (e.g., linearly), and may be moved via an interaction with the coil 106 when/if the magnetic field is applied/generated by the coil 106. The second valve unit 120 may be operated in conjunction with the first valve unit 110 and may be closely attached to or separated from the valve seat 104 to open and close the third passage 34 and/or fourth passage 36.

As an example, the body part 102 may have/form a cylindrical hollow portion 171 with open upper and lower sides. A solenoid core 108 for sealing the upper portion of the body part 102 may be installed at an upper portion of the body part 102. A screw coupling part (not illustrated) may be screw-coupled to the valve body 10. The screw coupling part may be installed on the lower outer peripheral surface of the body part 102. An inlet 172 may be provided on a side of the lower peripheral surface. The inlet 172 may communicate with the fourth passage 36 such that the hydrogen fuel may enter and/or exits the fourth passage 36 via the inlet 172.

The coil 106 may generate a magnetic field for operating the first valve unit 110 (e.g., a first valve when/if an electric voltage is applied thereto. The coil 106 may be wound around the outer peripheral surface of a bobbin 130 and may magnetize the bobbin 130 and the solenoid core 108.

The solenoid core 108 may be coupled to an upper portion of the hollow portion 171. The solenoid core 108 may comprise a ferromagnetic material to effectively induce/amplify a magnetic field generated in the coil 106. For example, the solenoid core 108 may be formed of SUS 430FR or another material that is resistant to hydrogen embrittlement.

The bobbin 130 may have a hollow spool shape. The bobbin 130 may be manufactured of a synthetic resin to be electrically cut off/insulated from the coil 106 and an upper plunger 111 and the solenoid core 108 in the body part 102.

A first space part 140 (e.g., a first space), in which the first valve unit 110 is disposed to be movable linearly (e.g., in a longitudinal direction of the first valve unit 110), may be formed in the interior of the body part 102 (e.g., in an interior of the second valve part 120). A second space part 150 (e.g., a second space) may be disposed/formed in an interior of the body part 102 at a portion lower than and/or overlapping the first space part 140. The second space part 150 may have a larger inner diameter than that of the first space part 140. The second valve unit 120 may be disposed in the second space part 150 to be linearly movable, may be formed in an interior of the body part 102.

The valve seat 104 located in the second space part 150 may include an outlet 173 fixed to a lower portion of the body part 102, and from which the hydrogen fuel may be discharged.

The first valve unit 110 may include the upper plunger 111 that is installed in the first space part 140 of the body part 102 to be linearly moved. The upper plunger 111 may interact with the coil 106 such as to be linearly moved when/if a magnetic field is applied to the coil 106 (e.g., based on the magnetic field applied to the coil 106). The first valve unit 110 may include a pilot rod 112 that is inserted into an interior of the upper plunger 111, and configured to be linearly moved. The first valve unit 110 may include a seal member 113 (e.g., a poppet, a seal) that is disposed to extend from a lower portion of the pilot rod 112 to open and close an orifice 122. The first valve unit 110 may include and a spring 114 installed between the pilot rod 112 and the solenoid core 108 to provide an elastic force so that the seal member 113 may be closely attached (e.g., pressed) to the orifice 122.

The first valve unit 110 may be operated, based on whether electric power is applied to the coil 106, to open or close the orifice 122.

The first valve unit 110 may be a normal close type. When/if electric power is cut off (e.g., from the coil 106, not applied to the coil 106, etc.), the upper plunger 111 and the pilot rod 112 may be elastically supported (e.g., pushed/pressed) downward by the spring 114 and may block the orifice 122.

When/if the electric power is switched on/applied to the coil 106, the solenoid core 108 may be magnetized by the magnetic field generated by the coil 106, and the magnetized solenoid core 108 may draw the upper plunger 111 and the pilot rod 112 upward (e.g., out of/away from the orifice 122), so that the orifice 122 may be opened.

When/if the electric power is switched off, the load applied to the upper plunger 111 and the pilot rod 112 may be less than the elastic force of the spring 114, so that the upper plunger 111 and the pilot rod 112 may be lowered/maintained blocking the orifice 122 by the elastic force of the spring 114.

When/if the electric power is switched on, the drawing force of the solenoid core 108 may be greater than the sum of the load applied to the upper plunger 111 and the pilot rod 112 (e.g., the elastic force of the spring 114), so that the elastic force of the spring 114 may be overcome and the upper plunger 111 and the pilot rod 112 may be raised (e.g., away from/out of the orifice 122.

The upper plunger 111 may be formed of a ferromagnetic material that may induce a magnetic field like the solenoid core 108. For example, the upper plunger 111 may be formed of SUS 430FR that is resistant to hydrogen embrittlement.

The solenoid core 108 and the upper plunger 111 may secure a strength against hydrogen embrittlement by minimizing exposure of the body part 102 to the external environment, so that the durability of the solenoid valve 15 may be improved.

A spring mounting portion 112a of the pilot rod 112 may have a small outer diameter (e.g., relative to a non-spring mounting portion of the pilot rod 112). the spring mounted portion 112a may be formed at an upper portion of the pilot rod 112. The spring 114 may be mounted on the spring mounted portion 112a)

The seal member 113 may have a poppet formed in a column shape, but is not limited thereto, and a ball shape may be adopted.

A ring member (e.g., a ring/a seal) for sealing may be installed between the upper plunger 111 of the first valve unit 110 and the body part 102, into which the upper plunger 111 may be inserted. The ring member may include an O-ring 174, and/or one or more of (e.g., a plurality of) backup rings 175 that are closed attached to, for example, one side and an opposite side of the O-ring 174 to improve the performance of the O-ring 174 and improve the life of the O-ring 174.

Furthermore, a ring member for preventing leakage of the hydrogen fuel may be installed between the solenoid core 108 and the body part 102, into which the solenoid core 108 is inserted. The ring member may include an O-ring 174′ and/or a backup ring 175′ and/or a plurality of backup rings 175′.

An orifice 122, through which the hydrogen fuel may passes through in a vertical direction, may be formed in the second valve unit 120. A curved attachment part 126, in which the valve seat 104 may be closely attached to open and close the outlet 173, may be formed at a lower portion the orifice 122.

The second valve unit 120 may include a lower plunger 121 corresponding to the upper plunger 111 of the first valve unit 110.

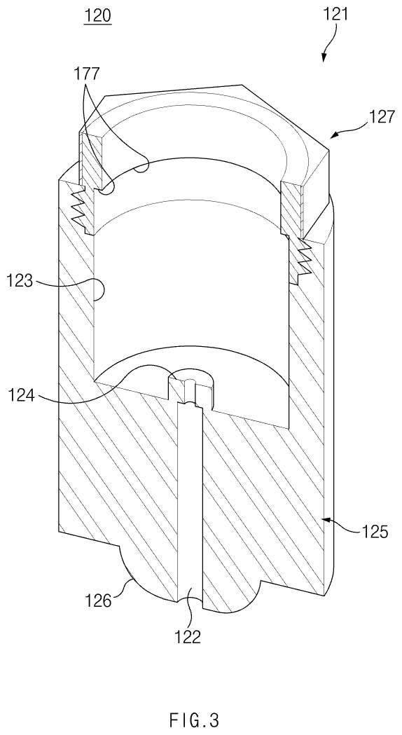

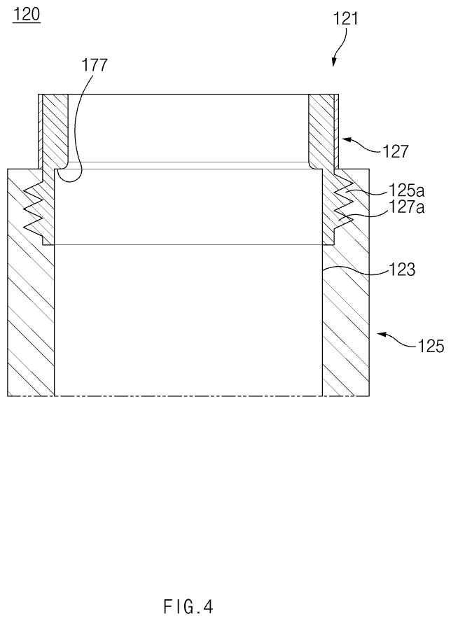

FIG. 3 is a perspective view illustrating a coupled state of the first and second plungers of the second valve unit 120 according to an example of the present disclosure, and FIG. 4 is a cross-sectional view of FIG. 3.

As illustrated in FIGS. 3 and 4, the lower plunger may include a first plunger 125. The first plunger 125 may include a cylindrical part 123, into which the upper plunger 111 may be inserted to be slid, may be formed on the lower plunger 121 of the second valve unit 120. A protrusion 124 that protrudes upward (e.g., towards the first valve unit 110) may be formed at the center of the bottom inner surface of the first plunger 125/lower plunger 121. An orifice 122 may be formed in the first plunger 125 to extend from the center of the protrusion 124 through a bottom outer surface of the first plunger 125/lower plunger 121.

The lower plunger 121 may include a second plunger 127 that is coupled to the cylindrical part 123 of the first plunger 125 and is installed on the inner peripheral surface of the body part 102 to be linearly moved together with the first plunger 125.

In the lower plunger 121, a first screw part 125a (e.g., first threads) may be formed on an inner surface of the cylindrical part 123 formed in the first plunger 125, and a second screw part 127a (e.g., second threads configured to be fastened to/mate with the first screw part 125a) may be formed on an outer surface of the second plunger 127.

The first plunger 125 and the second plunger 127 may be firmly coupled to each other by screw-coupling the first screw part 125a and the second screw part 127a.

The second screw part 127a of the second plunger 127 may be formed in a lower area of the outer surface of the second plunger 127. An inner surface of the second plunger 127, corresponding to the outer surface of the second plunger 127 on which the second screw part 127a is formed, may be formed to have a larger inner diameter relative to that of an upper area of the second plunger 127. That is, the upper area of the inner surface of the second plunger 127 may be formed to have a smaller diameter than the lower area, and the lower area may be formed to have a larger diameter part than the upper area, so that a stepped part 177 is formed on an inner surface of the second plunger 127 between the upper area and the inner area.

The second plunger 127 may be easily coupled to the first plunger 125 through a tool, such as a wrench (e.g., a wrench in the shape of a polygonal tube, such as a hexagonal tube, but the shape may be changed/selected as necessary).

When/if the upper plunger 111 is coupled to the lower plunger 121, it may not be easy to be coupled to a hollow portion 123 of the lower plunger 121 due to a side protrusion 111a of the upper plunger 111, which will be described later, so that the lower plunger 121 may be separated into two parts (e.g., the first and second plungers 125 and 127). The second plunger 127 (e.g., in the shape of a hexagonal tube) may be easily separated by using a tool having a corresponding shape.

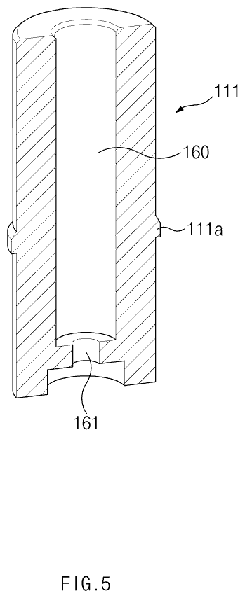

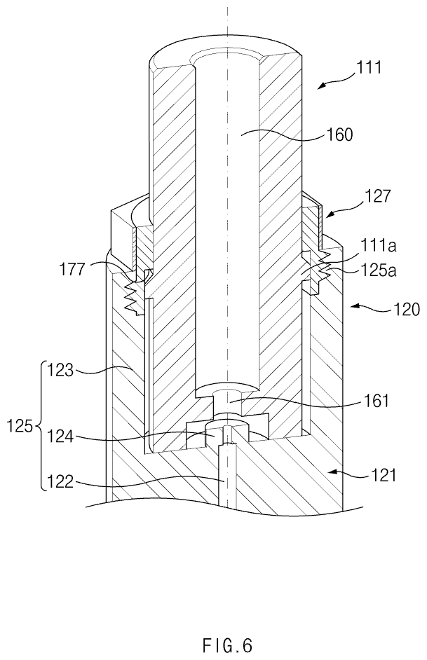

FIG. 5 is a cutaway perspective view illustrating the upper plunger according to an example of the present disclosure, and FIG. 6 is a cutaway perspective view illustrating a coupling state of the upper plunger and the lower plunger according to an example of the present disclosure.

As illustrated in FIGS. 5 and 6, a third space part 160, into which the pilot rod 112 may be inserted, may be formed in the upper plunger 111 of the first valve unit 110. A guide hole 161 having a size that allows the seal member 113 to pass may be formed at a lower portion of the third space part 160. The guide hole may allow for the seal member 113 to be guided to contact the protrusion 124, in which the orifice 122 is formed.

A side protrusion 111a may protrude along the circumference of the outer surface of the upper plunger 111.

The side protrusion 111a may be supported while contacting the inner surface of the cylindrical part 123 of the first plunger 125, so as to secure airtightness of the first plunger 125. Because the side protrusion 111a secures airtightness of the first plunger 125, the hydrogen fuel introduced into the first space part 140 (e.g., through a passage between the inner wall of the body part 102 and the outer surface of the second valve unit 120) through the inlet 172 may be blocked.

Furthermore, in an example of the present disclosure, the lower plunger 121 may be formed of a metallic material. The valve seat 104 that contacts the lower plunger 121 may be formed of a nonmetallic material that is not deformed due to a high pressure, which may prevent deformation of the lower plunger 121 and the valve seat 104 due to a high-pressure impact, by which the valve may be opened and/or closed. The lower plunger 121 corresponding to the upper plunger 111 may be formed of a metallic material in an aspect of durability while/if the upper plunger 111 may be formed of a metallic material.

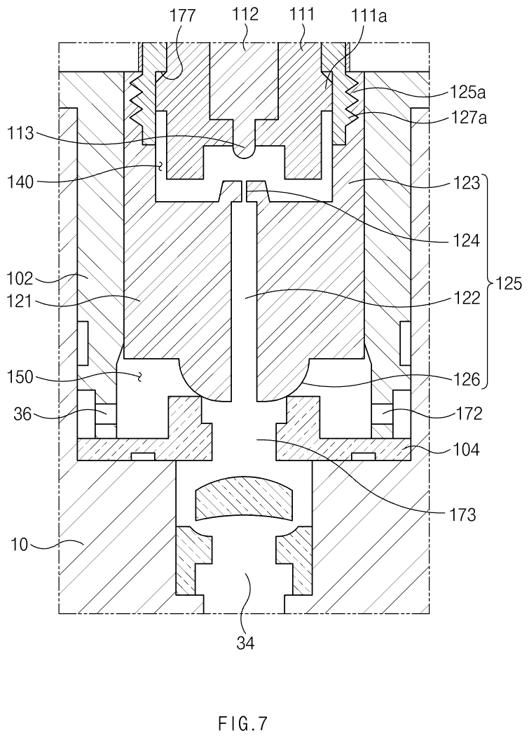

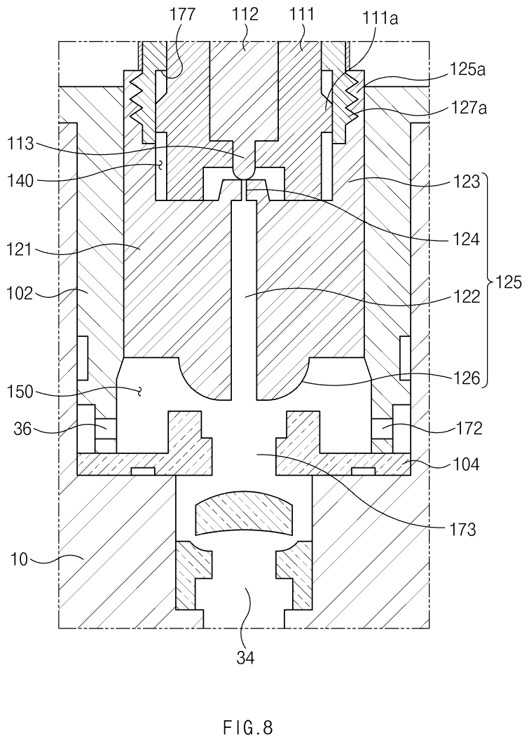

FIGS. 7 and 8 are operation views illustrating an operation state of a flow rate control valve according to an example of the present disclosure, and the operation of the flow rate control valve according to an example of the present disclosure will be described.

First, the lower plunger 121 of the second valve unit 120 may be closely attached to (e.g., in contact with and/or pressed to) the valve seat 104, and the seal member 113 of the pilot rod 112 may be closely attached to the orifice 122 by the elastic force of the spring 114, so that the fourth passage 36 is blocked, and the supply of hydrogen fuel to the user (e.g., fuel cell stack) of the hydrogen fuel is stopped.

In this case, the pressure states of the first space part 140 and the second space part 150 become the same pressure state (equilibrate pressures) as/because the seal member 113 is closely attached to the orifice 122 and maintains a blocking state of blocking the orifice 122.

In this state, when/if electric power is applied to the coil 106, as illustrated in FIG. 7, the upper plunger 111 may be raised, and the pilot rod 112 inserted into the third space part 160 of the upper plunger 111 opens the orifice 122 while being raised.

The high-pressure hydrogen fuel filled in the first space part 140 may be discharged to the outlet 173 through the orifice 122, and thus, the hydrogen fuel filled in the first space part 150 may become a low-pressure state.

The hydrogen fuel introduced through the passage between the inner wall of the body part 102 and the outer surface of the lower plunger 121 of the second valve unit 120 through the inlet 172 of the body part 102 may be blocked by the side protrusion 111a that protrudes to the inner surface of the cylindrical part 123 of the lower plunger 121 from the upper plunger 111. Accordingly, the first space part 140 may maintain a low-pressure state, in a state in which the hydrogen fuel is not introduced into the first space part 140.

Furthermore, the flow of the hydrogen fuel introduced into the upper portion of the hollow portion 171 of the body part 102 may be blocked by ring members (e.g., the O-ring 174 and the backup ring 175) that maintain airtightness between the upper plunger 111 and the inner wall of the hollow portion 171 of the body part 102.

As illustrated in FIG. 8, the high-pressure hydrogen fuel that acts on the lower portion of the lower plunger 121 in the second space part 150 raises the lower plunger 121 upward by the differential pressure from the low-pressure hydrogen fuel in the first space part 140.

Accordingly, the outlet 173 of the valve seat 104 may be opened, and, while/if the third passage 34 and the fourth passage 36 communicate with each other, the hydrogen fuel stored in the hydrogen storage tank may be supplied to the user (e.g., fuel cell stack) of the hydrogen fuel through the use pipe 20.

Accordingly, in the present disclosure, the normal operation of the solenoid valve 15 may be made possible by the smooth operation of the second valve unit 120 due to the generation of a differential pressure within the operation sections of the first and second valve units 110 and 120, and thus, normal driving of the vehicle is enabled, so that complaints of the customers may be completely solved.

The present disclosure has been made to solve the above-mentioned problems occurring in the prior art while advantages achieved by the prior art are maintained intact.

The present disclosure provides a flow rate control valve, by which an operation of a solenoid valve is operated more accurately and smoothly even when a larger difference pressure occurs between a hydrogen storage tank and a pipeline.

The present disclosure also provides a flow rate control valve, by which a normal operation of a solenoid valve is made possible by a smooth operation of a second valve unit due to generation of a differential pressure within operation sections of first and second valve units, and thus, normal driving of the vehicle is enabled, so that complaints of the customers may be completely solved.

The technical problems to be solved by the present disclosure are not limited to the aforementioned problems, and any other technical problems not mentioned herein will be clearly understood from the following description by those skilled in the art to which the present disclosure pertains.

According to the present disclosure, a flow rate control valve includes a body part, in which an inlet and an outlet of a hydrogen fuel are formed at a lower portion thereof, a coil installed on an outer peripheral surface of the body part, and to which a magnetic field is applied, a solenoid core installed at a hollow portion of the body part, and that induces the magnetic field applied by the coil, a first valve unit disposed at the hollow portion of the body part to be movable, and a second valve unit disposed to be movable in conjunction with the first valve unit, and having an orifice in an interior thereof, the body part includes a first space part being an area between the first valve unit and the second valve unit, and a second space part disposed at a lower portion of the first space part, formed to have a larger inner diameter than that of the first space part, and being an area between the second valve unit and the outlet, the first valve unit is configured to block the first space part in a state, in which the first valve unit is raised, and the second valve unit is configured to open the outlet while being raised due to a differential pressure of the first space part and the second space part.

The first valve unit may include an upper plunger installed at the hollow portion of the body part to be raised, a pilot rod inserted into an interior of the upper plunger to be linearly moved, a seal member disposed at a lower portion of the pilot rod, and that opens and closes the orifice, and a spring installed between the pilot rod and the solenoid core, and that provides an elastic force to the pilot rod.

The second valve unit may include a lower plunger including a first plunger, in which a cylindrical part, into which the upper plunger is inserted, is formed, in which a protrusion protruding upward is formed at a center of a bottom surface thereof, and in which an orifice is formed at a center of the protrusion, and a second plunger coupled to the cylindrical part of the first plunger.

A first screw part may be formed on an inner surface of the cylindrical part of the first plunger, and a second screw part coupled to the first screw part may be formed on an outer surface of the second plunger.

The second screw part may be formed in a lower area of the outer surface of the second plunger, and an inner surface of the lower area of the second plunger has a larger inner diameter than that of an upper area.

A side protrusion protruding along a circumference of an outer surface of the upper plunger may be formed on the outer surface of the upper plunger, and the side protrusion may contact an inner surface of a lower area of the second plunger.

An inner surface of the second plunger may include a stepped part, an upper area of which is formed as a small diameter part and a lower area of which is formed as a larger diameter part.

An upper area of the second plunger may have a polygonal pipe shape.

When the first valve unit is raised, the hydrogen fuel introduced into the first space part may be blocked by the side protrusion, and a pressure of the first space part may be lower than that of the second space part.

A ring member for sealing may be installed between the upper plunger, and the body part, into which the upper plunger is inserted, and the ring member may include an O-ring, and a plurality of backup ring closely attached to opposite sides of the O-ring.

The solenoid core, the upper plunger of the first valve unit, and the lower plunger of the second valve unit may be formed of a metallic material, and the solenoid core and the upper plunger may be formed of a ferromagnetic material.

The above-mentioned description of the present disclosure is intended to be illustrative, and it should be understood by those skilled in the art that the present disclosure may be embodied in other specific forms without departing from the spirit or essential characteristics thereof. Therefore, the above-described examples are examples in all aspects, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. A flow rate control valve comprising:
a body comprising a lower portion in which an inlet and an outlet are formed;
a coil installed on an outer peripheral surface of the body, and configured to apply a magnetic field;
a solenoid core installed in a hollow portion of the body, and configured to induce the magnetic field applied by the coil;
a first valve plunger moveably installed in the hollow portion of the body; and
a second valve plunger disposed to be movable in conjunction with the first valve plunger, and having an orifice in an interior the second valve plunger,
wherein the body forms a first space between the first valve plunger and the second valve plunger and forms a second space between the second valve plunger and the outlet, wherein the second space has a larger diameter than the first space,
wherein the first valve plunger is configured to block the first space in a state in which the first valve plunger is raised, and
wherein the second valve plunger is configured to, based on a differential pressure between the first space and the second space, be positioned in a state in which the outlet is open.

2. The flow rate control valve of claim 1, wherein the first valve plunger comprises:
an upper plunger, installed in the hollow portion, configured to move linearly within the hollow portion;
a pilot rod, inserted into an interior of the upper plunger, configured to be linearly moved;
a seal protrusion disposed at a lower portion of the pilot rod, and configured to open and close the orifice; and
a spring, installed between the pilot rod and the solenoid core, configured to provide an elastic force to the pilot rod.

3. The flow rate control valve of claim 2, wherein the second valve plunger comprises a lower plunger comprising:
a first plunger that forms a cylindrical space, into which the upper plunger is inserted, wherein a protrusion protrudes from a bottom inner surface of the first plunger into the cylindrical space, and wherein the orifice is formed through the protrusion to a bottom outer surface of the first plunger; and
a second plunger coupled to a portion of the first plunger forming the cylindrical space.

4. The flow rate control valve of claim 3, wherein first threads are formed on an inner surface of the portion of the first plunger forming the cylindrical space, and
second threads are formed on an outer surface of the second plunger, wherein the second threads mate with the first threads.

5. The flow rate control valve of claim 4, wherein the second threads are formed on the outer surface in a lower portion of the second plunger, and an inner surface of the lower portion of the second plunger has a larger diameter than an inner surface of an upper portion of the second plunger.

6. The flow rate control valve of claim 3, wherein a side protrusion protrudes along a circumference of an outer surface of the upper plunger such that the side protrusion is in contact with an inner surface of a lower portion of the second plunger.

7. The flow rate control valve of claim 6, wherein an inner surface of an upper portion of the second plunger has a smaller diameter than an inner surface of a lower portion of the second plunger, and wherein a step is formed between the inner surface of the upper portion of the second plunger and the inner surface of the lower portion of the second plunger.

8. The flow rate control valve of claim 7, wherein an upper portion of the second plunger has a polygonal pipe shape.

9. The flow rate control valve of claim 6, wherein the side protrusion is configured to, in a state in which the first valve plunger is raised, block hydrogen fuel introduced into the first space, such that a pressure of the first space is lower than a pressure of the second space.

10. The flow rate control valve of claim 6, wherein a ring for sealing is installed between the upper plunger and the body.

11. The flow rate control valve of claim 10, wherein the ring comprises an O-ring and a plurality of backup rings on opposite sides of the O-ring.

12. The flow rate control valve of claim 3, wherein the solenoid core, the upper plunger of the first valve plunger, and the lower plunger of the second valve plunger comprise one or more metallic materials, and
wherein the solenoid core and the upper plunger comprise one or more ferromagnetic materials.

13. A flow rate control valve comprising:
a body comprising a lower portion forming an inlet;
a valve seat attached to the lower portion of the body and forming an outlet;
a conductive coil attached to an upper portion of the body;
a solenoid core arranged inside the conductive coil;
a first valve plunger comprising a side protrusion protruding outward around a circumference of the first valve plunger; and
a second valve plunger, movable installed in the body, comprising:
an upper cylindrical portion, wherein an inner surface of the upper cylindrical portion comprises an inward step; and
a lower orifice portion that forms an orifice,
wherein the first valve plunger is moveably inserted within the upper cylindrical portion such that the side protrusion is in contact with the inner surface of the upper cylindrical portion below the inward step, and
wherein a first space is formed between the side protrusion, a side of the first valve plunger, and the second valve plunger, and a second space is formed between the second valve plunger, the body, and the valve seat, wherein the second space has a larger diameter than the first space.

14. The flow rate control valve of claim 13, wherein the first valve plunger comprises:
an upper plunger configured to move linearly within the body and the upper cylindrical portion;
a pilot rod, inserted into an interior of the upper plunger, configured to be linearly moved;
a seal protrusion protruding from the pilot rod, and configured to open or close the orifice; and
a spring, installed between the pilot rod and the solenoid core, configured to provide an elastic force to the pilot rod.

15. The flow rate control valve of claim 13, wherein the side protrusion is configured to, in a state in which the first valve plunger is raised, block hydrogen fuel introduced into the first space, such that a pressure of the first space is lower than a pressure of the second space.

16. The flow rate control valve of claim 13, wherein a sealing ring is installed between the first valve plunger and the body.

17. The flow rate control valve of claim 16, wherein the ring comprises an O-ring and a plurality of backup rings on opposite sides of the O-ring.

18. The flow rate control valve of claim 13, wherein the solenoid core, the first valve plunger, and the second valve plunger comprise one or more metallic materials, and
wherein the solenoid core and the first valve plunger comprise one or more ferromagnetic materials.

19. The flow rate control valve of claim 13, wherein the upper cylindrical portion comprises a first plunger and a second plunger attached to an upper portion of the first plunger, and wherein the inward step is formed in an inner surface of the second plunger.

20. The flow rate control valve of claim 19, wherein the second plunger is attached to the upper portion of the first plunger via mated threads.
